(19) United States
(12) Patent Application Publication
(10) Pub. No.: US 2004/0258990 A1
(43) Pub. Date: Dec. 23, 2004

(54) Electrochemical cell with curable liquid electrolyte and method of making

(76) Inventors: Gerard Francis McLean, West Vancouver (CA); Colleen Legzdins, West Vancouver (CA); Jianfei Yu, Burnaby (CA); Martin Perry, Sunnyvale, CA (US)

Correspondence Address: BUSKOP LAW GROUP, P.C., 1717 ST. JAMES PLACE, SUITE 500, HOUSTON, TX, 77056, US

(21) Appl. No.: 10/781,196

(22) Filed: Feb. 18, 2004

Related U.S. Application Data
(60) Provisional application No. 60/479,788, filed on Jun. 19, 2003.

(51) Int. Cl. H01M 8/00; H01M 8/10; H01M 6/04; B23P 19/00

(52) U.S. Cl. 429/188; 29/729

(57) ABSTRACT

The invention is an electrochemical cell made of a first electrode, a second electrode, and a curable liquid electrolyte located between the first and second electrodes, wherein the curable liquid electrolyte is made of a protonic polymer having an polymeric backbone with side chains with acidic groups for conducting proton for an electrochemical cell, a first vinyl monomer with a —(COOH)— group, and a cross linking agent with a second vinyl monomer.

### FIELD OF THE INVENTION

The present invention relates to an electrochemical cell made of two electrodes and a curable liquid electrolyte and the method for forming such an electrochemical cell.

### BACKGROUND OF THE INVENTION

The present application claims priority to co-pending U.S. Provisional Patent Application Ser. No. 60/479,788 filed on Jun. 19, 2003.

Polymer electrolyte membranes are useful in electrochemical devices such as batteries and fuel cells since they function as an electrolyte and also as a reactant separator. Typical membranes of this type are fabricated as thin films and then incorporated into cells and systems of various configurations.

Perflourinated hydrocarbon sulfonate ionomers such as Nafion™ by Dupont or analogous Dow perflourinated membranes are presently used as polymer electrolyte membranes for fuel cells. Such prior art membranes, however, possess severe limitations which, in addition to their cost, detract from their utility in new and advanced fuel cell designs.

Nafion™ is a costly material but is difficult to replace due to its combined electrochemical performance and mechanical toughness. Other membranes possess compromising properties, e.g., sulfonated polystyrenes, which degrade more rapidly than Nafion™, sulfonated polyaromatics often adversely swell in water and form poor interfaces with catalyst layers; PBI/phosphoric acid membranes do not operate below 120 degrees Celsius. It is hard to find a low cost alternative to Nafion™ because of the difficulties in finding suitable materials, synthetic methods, and the limited choice in base materials.

However, while Nafion™ is so far the membrane material of choice, it is by no means ideal. Nafion membranes soften only at temperatures >300 degrees Celsius, sulfonated polyaromatics also possess very high softening temperatures and simultaneously degrade. Solid polymer electrolytes inherently possess very high softening temperatures by virtue of their high concentration of ions. Thus processing of membrane films to produce assemblies of membranes and catalyzed electrodes are restricted to high pressure, high temperature compression techniques, a far from satisfactory situation. Due to the lack of alternative materials and the high softening temperatures of ionic polymers, it is hard to solve this problem. These results is an overall limitation of the ways in which the electrochemical device into which the membrane is used can be manufactured. This also places constraints on material selection for the other components of the electrochemical device, since these must now be subject to the very high temperatures and pressures required to form electrode—electrolyte interfaces. As new applications for electrochemical devices emerge, and particularly as the scale of the devices is reduced, the limitations posed by the electrolyte properties puts severe constraints on the feasibility of new designs.

Delamination of the membrane from the catalyst layer is a known mechanism of degradation of membrane—electrode assemblies. Delaminating is due to poor chemical or physical bonding. It is hard to match the chemical nature of the membrane with the catalyst layer, or to form a chemical bond between the membrane and the catalyst layer. This failure mechanism is therefore a direct consequence of the manufacturing constraints imposed by the mechanical properties of the membrane material.

There is a need within the design of electrochemical cells for polymer electrolyte membranes having different properties than the Nafion like materials. It would be desirable to have materials with similar electrochemical properties but which have different mechanical properties. Specifically there is a need for materials which become soft and pliable at lower temperatures and which can be brought into intimate contact with catalyzed electrodes of arbitrary three dimensional shape without the use of high temperature compression methods.

Depositing a membrane in a liquid form onto catalyst layers and subsequently curing it to produce a solid MEA that would greatly improve the adhesion between layers, especially if the pre-cured liquid membrane were incorporated into the catalyst layers. A curable liquid electrolyte would provide options for assembly of electrochemical cells not currently available, allow for fabrication of new topologies of electrochemical cells, would allow the consideration of new materials for complementary components in electrochemical cells, would potentially avoid major failure mechanisms of electrochemical cells and could lead to overall reduced costs of both materials and manufacturing.

### SUMMARY OF THE INVENTION

The current invention is an electrochemical cell made of two electrodes. A curable liquid electrolyte is located between the two electrodes. The curable liquid electrolyte is a solution of a protonic polymer with a polymeric backbone having side chains of acidic groups, a first vinyl monomer with a —(COOH)— group, and a cross linking agent with a second vinyl monomer.

The invention relates to a method for making an electrochemical cell using the novel curable electrolyte.

### BRIEF DESCRIPTION OF THE DRAWINGS

The present invention will be explained in greater detail with reference to the appended figures.

FIG. 1 is a perspective view of the electrochemical cell of the invention.

FIG. 2 is a cross sectional view of a fuel cell according to the invention.

FIG. 3 is a top view of another embodiment of a fuel cell according to the invention.

FIG. 4 is a side view of another embodiment of the invention.

FIG. 5 is a cross sectional view of an assembled electrochemical cell into which curable liquid electrolyte is being added.

FIG. 6 is a perspective view of an alternative embodiment of an electrochemical cell into which a curable liquid electrolyte is placed.

FIG. 7 shows an alternative method for placing a curable liquid electrolyte into a fuel cell.

The present invention is detailed below with reference to the listed Figures.

### DETAILED DESCRIPTION OF THE PREFERRED EMBODIMENTS

Before explaining the present invention in detail, it is to be understood that the invention is not limited to the particular embodiments and that it can be practiced or carried out in various ways.

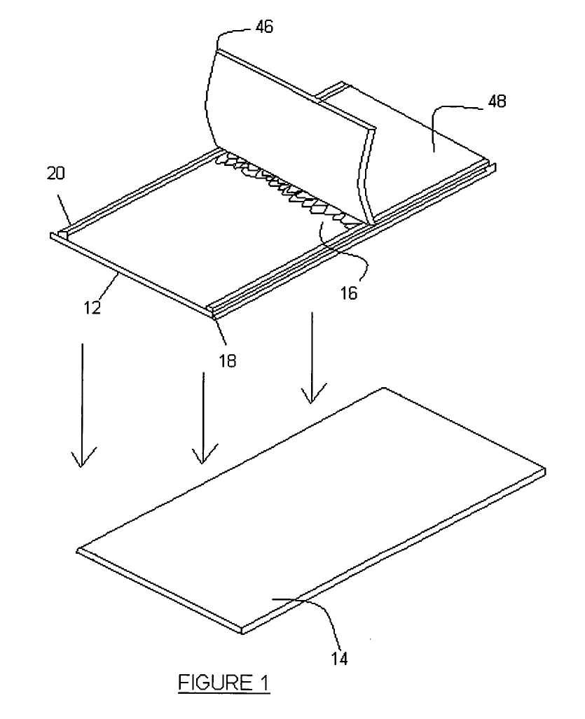

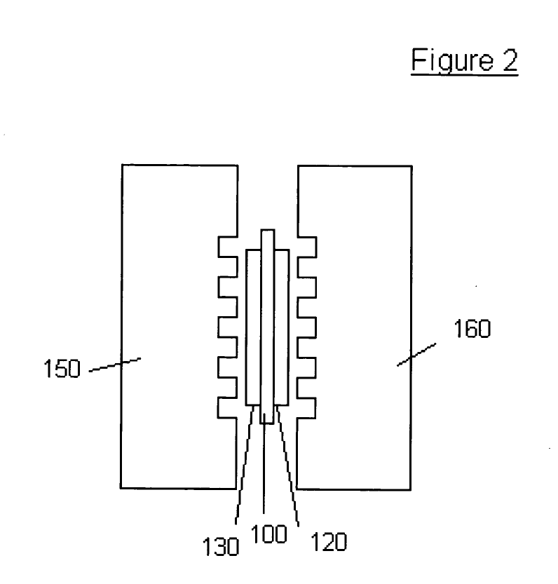

The invention is an electrochemical cell. The invention is shown in its preferred embodiment in FIG. 1. The electrochemical cell has a first electrode (12), a second electrode (14), and a curable liquid electrolyte (16) located between the first and second electrodes. In this perspective view, the electrochemical cell includes two spacers. The first spacer (18) is shown connected to the first electrode (12) on one end and the second electrode (14) on the other end. The second spacer (20) is shown connected to the first electrode (12) on one end and the second electrode (18) on the other end. The curable liquid electrolyte is disposed between the first and second spacers. FIG. 1 shows that a flat blade (46) is used to form a smooth deposited electrolyte layer (48). When the second electrode (14) is placed over the layer (48), a precursor (not shown) is formed. FIG. 2 shows an embodiment of the invention where the electrochemical cell comprises a first flow field plate (150) and a second flow field plate (160). Disposed between these plates is an electrolyte sheet (100) formed from the curable electrolyte mentioned above. On one side of the electrolyte sheet (100) is a first diffusion electrode (120) adjacent the second flow field plate and a second diffusion electrode (130) adjacent the first flow field plate (150).

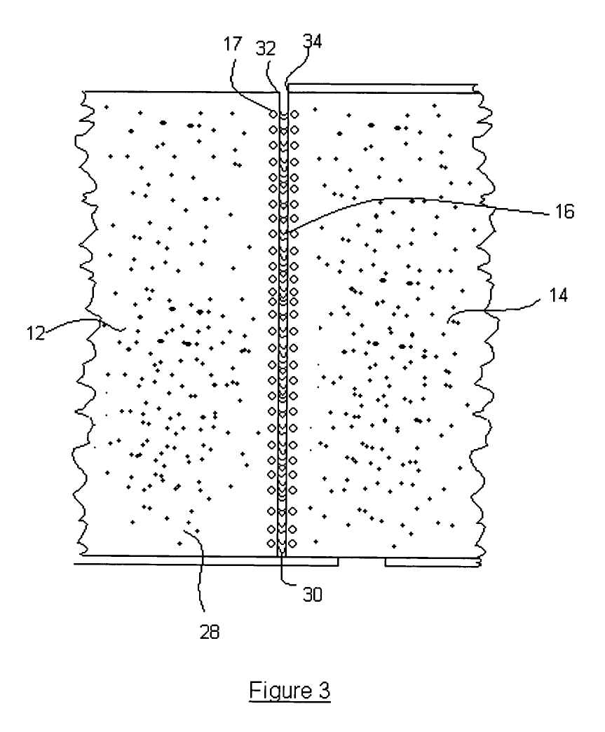

The invention includes an embodiment of an electrochemical cell with a porous substrate (28) as shown in FIG. 3, and at least one channel (30) located in the porous substrate (28), such as a porous media. The channel (30) has a first channel wall (32) and second channel wall (34). The first electrode (12) is located in the first channel wall and is the cathode region. The second electrode (14) is located in the second channel wall and forms the anode region. The curable liquid electrolyte (16) is located in the channel (30). A catalyst (17) can be disposed on first channel wall (32), the second channel wall (34) or both.

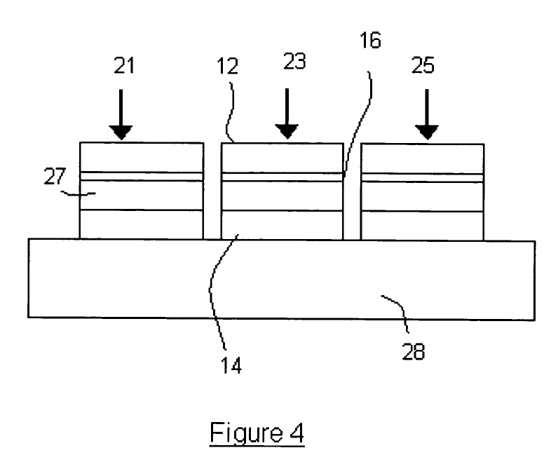

The substrate used in the invention can be a carbon filled epoxy, composites, a carbon filled polymer, a magnelli phase titanium oxide, or combinations thereof. In addition, the substrate can also be a foam, a monolith of porous material, an aero gel, a mat, felt, paper, mesh, laminates thereof, composites thereof, or combinations thereof. As shown in FIG. 4, the substrate (28) can be planar.

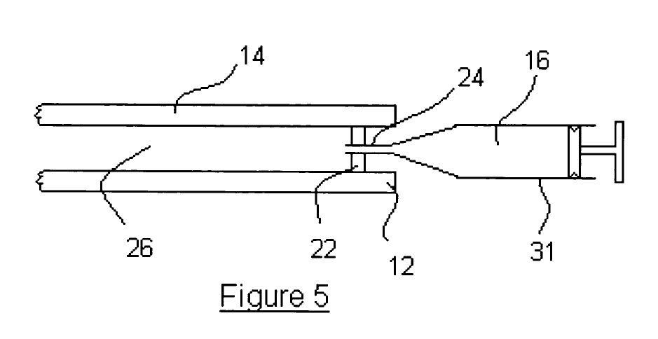

FIG. 4 illustrates a side view of an embodiment of the invention. The second electrolyte (14) can be disposed over the planar substrate (28). Curable electrolyte (16) can be deposited over the second electrolyte (14) and the first electrolyte (12) can be deposited over the curable liquid electrolyte described above. These constructs can be built in mini-towers (21, 23, and 25) separated by unfilled space. The electrochemical cell contemplates that a spacer (22) with an injection port (24) located between the first and second electrodes (12) and (14). The spacer (22) forms a cavity (26) wherein the curable liquid electrolyte (16) can be located. FIG. 5 shows this embodiment with injector (31).

The curable liquid electrolyte is made of a protonic polymer, a first vinyl monomer with a —(COOH)— group, and a cross linking agent with a second vinyl monomer. In the preferred embodiment, the first vinyl monomer is a vinyl phosphoric acid and the second vinyl monomer is di-vinyl sulphone.

The protonic polymer has a polymeric backbone with side chains containing acidic groups for conducting protons IN an electrochemical cell. The protonic polymers can be sulfonic acids, carboxylic acids, or phosphoric acids. The protonic polymer can also be a sulphonated polyether ether ketone.

The curable liquid electrolyte can further include a solvent, such as water, or a di-methyl acetamide. The curable liquid electrolyte can also optionally contain a photo-initiator or an elastising agent, such as acrylonitirle.

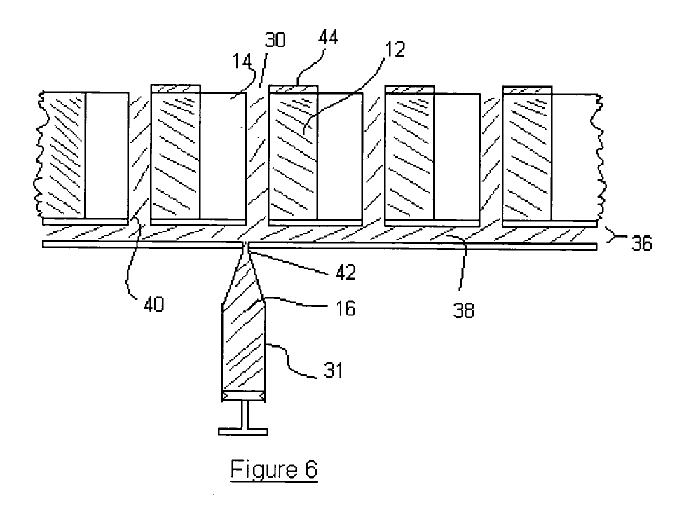

FIG. 6 shows the electrochemical cell can also include a base (36) with at least one distribution plenum (38), at least one fluid port (40) in fluid communication with the channel (30), and at least one master port (42). The distribution plenum (38) is used to transport the curable liquid electrolyte (16). The master port (42) is used to receive curable liquid electrolyte into the base, such as from an injector (31).

A cap (44) can be added to the electrochemical cell. The cap (44) is located over the first electrode (12) to seal the electrode region.

The invention includes a method for making an electrochemical cell with a curable liquid electrolyte. The method begins by mixing a Nafion™ containing a first solvent with a second solvent forming a mixture. The mixture is then heated in order to exchange the first solvent with the second solvent forming a second mixture. A third solvent is added to the second mixture forming a curable liquid electrolyte solution.

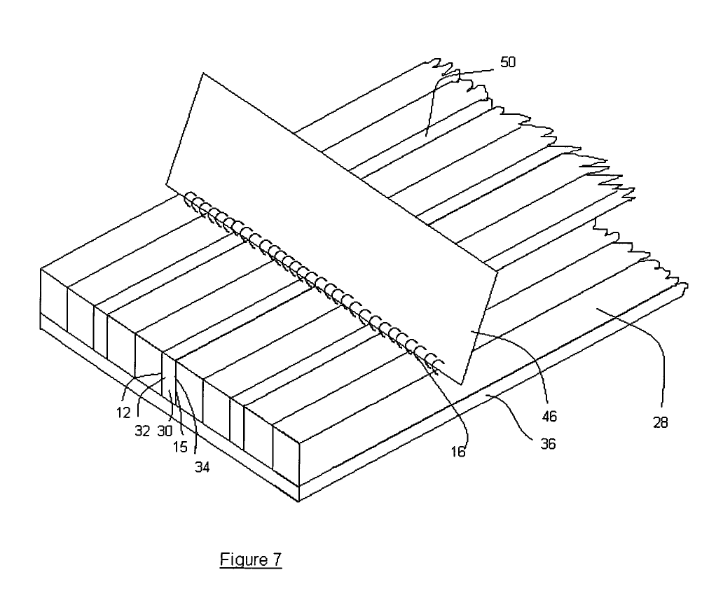

Once the curable liquid electrolyte solution is formed, the solution is placed on the first and second electrodes forming a precursor (50) as shown in FIG. 7. The curable electrolyte solution can be deposited on the first electrode using a flat blade (46) forming a deposited electrolyte layer. As an option, the second electrode is deposited onto the deposited electrolyte layer forming the precursor.

The precursor is then preferably treated by electron bombardment, electron beam treatment, thermal curing, or photo-curing. The treating process cures the curable liquid electrolyte into a material wherein at least a portion of the material is solid thereby forming the electrochemical cell.

As an alternative, the method can also involve adding a fourth solvent to the curable liquid electrolyte solution to reduce viscosity. The fourth solvent can be water, n-dimethyl acetamide, or combinations thereof.

In yet another embodiment, the method can include the step of adding an elastising agent, such as acrylonitirle, to the curable electrolyte solution to reduce brittleness.

When the method involves the steps of using at least one spacer having an injection port between the first and second electrodes forming a cavity wherein the curable liquid electrolyte is disposed in the cavity, the curable liquid electrolyte can be placed in the cavity by pouring, pumping or injecting the curable liquid electrolyte into the cavity.

While this invention has been described with emphasis on the preferred embodiments, it should be understood that within the scope of the appended claims, the invention might be practiced or carried out in other ways than as specifically described herein.

What is claimed is:

1. An electrochemical cell comprising:
a. a first electrode;
b. a second electrode;
c. a curable liquid electrolyte disposed between the first and second electrodes, wherein the curable liquid electrolyte comprises:
i. a protonic polymer having an polymeric backbone with side chains containing acidic groups for conducting protons in an electrochemical cell;
ii. a first vinyl monomer comprising a —COOH— group; and
iii. a cross linking agent comprising a second vinyl monomer.

2. The electrochemical cell of claim 1, wherein the protonic polymer comprises sulfonic acid, carboxylic acid, phosphoric acid or combinations thereof.

3. The electrochemical cell of claim 1, wherein the first vinyl monomer is a vinyl phosphoric acid.

4. The electrochemical cell of claim 1 wherein the second vinyl monomer comprises di-vinyl sulphone.

5. The electrochemical cell of claim 1, wherein the curable liquid electrolyte further comprises a solvent.

6. The electrochemical cell of claim 5, wherein the solvent is selected from the group consisting of water, di-methyl acetamide, and combinations thereof.

7. The electrochemical cell of claim 1, wherein the curable liquid electrolyte further comprises a photo-initiator.

8. The electrochemical cell of claim 1, wherein the protonic polymer is sulphonated polyether ether ketone.

9. The electrochemical cell of claim 1, wherein the curable liquid electrolyte further comprises an elasticizing agent.

10. The electrochemical cell of claim 9, wherein the elasticizing agent is acrylonitirle.

11. The electrochemical cell of claim 1, further comprising: a first spacer connected to the first electrode and the second electrode; and a second spacer connected to the first electrode and the second electrode, wherein the curable liquid electrolyte is disposed between the first and second spacers.

12. The electrochemical cell of claim 1, further comprising: a spacer having an injection port disposed between the first electrode and second electrode forming a cavity wherein the curable liquid electrolyte is disposed in the cavity.

13. The electrochemical cell of claim 1, further comprising:
a. a porous substrate;
b. at least one channel disposed in the porous substrate having a first channel wall and second channel wall; and
c. wherein the first electrode is disposed in the first channel and the second electrode is disposed in the second channel wall, and the curable liquid electrolyte is disposed in the channel.

14. The electrochemical cell of claim 1, wherein the substrate is a porous media.

15. The electrochemical cell of claim 1, wherein the substrate comprises a carbon filled epoxy, a carbon filled polymer, a magnelli phase titanium oxide or combinations thereof.

16. The electrochemical cell of claim 13, wherein the substrate comprises a foam, a monolith of porous material, an aero gel, a mat, a felt, paper, mesh, laminates thereof, composites thereof or combinations thereof.

17. The electrochemical cell of claim 13, further comprising:
a. a base comprising at least one distribution plenum for transporting curable liquid electrolyte;
b. at least one fluid port in fluid communication with the channel; and
c. at least one master port for receiving curable liquid electrolyte into the base.

18. The electrochemical cell of claim 17, further comprising a cap disposed over the first electrode to seal the electrode.

19. A method for making an electrochemical cell comprising:
a. forming a curable liquid electrolyte comprising:
b. mixing a first vinyl monomer with a cross linking agent comprising a second vinyl monomer to form a mixture;
c. dissolving a protonic polymer having an polymeric backbone with side chains containing acidic groups into the mixture to form a curable liquid electrolyte solution;
d. disposing the curable liquid electrolyte solution on first and second electrodes to form a precursor; and
e. treating the precursor using a procedure selected from the group consisting of electron bombardment, electron beam treatment, thermal curing, photo-curing to cure the curable liquid electrolyte into a material, wherein at least a portion of the material is solid, thereby forming an electrochemical cell.

20. The method of claim 19, further comprising of adding a solvent to the curable liquid electrolyte solution to reduce viscosity.

21. The method of claim 20, wherein the solvent is selected from the group consisting of water, n-dimethyl acetamide, and combinations thereof.

22. The method of claim 19, further comprising of adding an elasticizing agent to the curable electrolyte solution to reduce brittleness.

23. The method of claim 22, wherein the elasticizing agent is acrylonitirle.

24. The method of claim 19, wherein the curable electrolyte solution is deposited on the first electrode using a flat blade to form a deposited electrolyte layer and then the second electrode is deposited onto the deposited electrolyte layer forming the precursor.

25. The method of claim 19, further comprising using a spacer having an injection port between the first and second electrodes forming a cavity wherein the curable liquid electrolyte is disposed in the cavity.

26. The method of claim 25, wherein the curable liquid electrolyte is disposed in the cavity by pouring the electrolyte into the cavity, pumping the curable liquid electrolyte into the cavity, and injecting the electrolyte into the cavity.

27. The method of claim 19, further comprising:
a. a porous substrate;
b. at least one channel disposed in the porous substrate having a first channel wall and second channel wall; and
c. wherein the first electrode is disposed in the first channel wall, the second electrode is disposed in the second channel wall, and the curable liquid electrolyte is disposed in the channel.

28. The method of claim 19, further comprising:
a. a base comprising at least one distribution plenum for transporting curable liquid electrolyte;
b. at least one fluid port in fluid communication with the channel; and
c. at least one master port and inserting curable liquid electrolyte into the distribution plenum through the at least one master port and then flowing the curable liquid electrolyte through the fluid port into the channel.
